(19) United States
(12) Patent Application Publication
(10) Pub. No.: US 2026/0349389 A1
(43) Pub. Date: Nov. 5, 2026

(54) HOROLOGICAL COMPONENT WITH SEPARATE CROSSED BLADES AND ITS MANUFACTURING METHOD

(71) Applicant: PATEK PHILIPPE SA GENEVE, Genève (CH)

(72) Inventors: Sylvain GEISER, Plan-les-Ouates (CH); David CHABLOZ, Plan-les-Ouates (CH)

(21) Appl. No.: 19/487,177

(22) PCT Filed: May 22, 2024
(86) PCT No.: PCT/IB2024/054946

§ 371 Date: Nov. 24, 2025

(30) Foreign Application Priority Data
May 24, 2023 (EP) 23175061.3

(51) Int. Cl. G04B 17/04; G04B 17/32; G04D 3/00

(52) U.S. Cl. CPC G04B 17/045; G04B 17/32; G04D 3/0038

(57) ABSTRACT

The horological component with separate crossed blades (1) according to the invention comprises an assembly of a first part (3) and a second part (4) that are superimposed. The first part (3) comprises first and second rigid sections (5, 6) connected by a first elastic blade (7). The second part (4) comprises third and fourth rigid section (8, 9) connected by a second elastic blade (10). The first and third rigid sections (5, 8) are rigidly connected to each other. The second and fourth rigid sections (6, 9) are rigidly connected to each other. The first and second elastic blades (7, 10) extend in parallel planes and in different directions to cross without contact. A first spacer (25a, 26a) rigidly connected to or forming part of the first rigid section (5) and a second spacer (25b, 26b) rigidly connected to or forming part of the second rigid section (6) ensure a height spacing of the first and second elastic blades (7, 10). The first and second spacers (25a, 26a, 25b, 26b) originate from the etching of a single substrate.

The present invention relates to a horological component with separate crossed blades, such as an oscillator, a rocker or a support for an oscillator or a rocker, for example.

Separate crossed blades are a particularly popular type of flexible pivot guiding a movable section in rotation around a virtual axis of rotation relative to a base intended to be fixed to a frame. The separate crossed blades connect the movable section to the base while extending in two parallel planes and in different directions to cross without contact.

A difficulty encountered when manufacturing a component with separate crossed blades is to ensure that the blades are sufficiently spaced apart in height so that they do not touch each other during operation of the component, particularly during movements of the user's wrist. Contact between the two blades can in fact result in a reduction in the precision of the watch. Additionally, shocks received by the watch can cause the blades to collide and cause damage.

Patent application WO 2021/186333 of the present applicant proposes, in the case of a silicon component with separate crossed blades, to increase the spacing of the blades by subjecting the latter to several oxidation-deoxidation sequences. This solution is effective but it leads to a modification of the dimensions of the blades, an effect which must be anticipated in the calculations and which complicates the theoretical study of the component. Furthermore, the spacings that can be achieved with this solution are relatively small (in the order of ten micrometers). Another disadvantage is the length of the process, the number of oxidation-deoxidation sequences required being proportional to the desired increase in the spacing of the blades.

Another solution is described in patent application WO 2022/009102 of the present applicant. It consists of producing the component with separate crossed blades in the form of an assembly of two superimposed parts, each comprising one of the blades, one stage of the base and one stage of the movable section, and separating these two parts in height by two metal spacers in the base and the movable section respectively, the spacer of the movable section being constituted by a diametrical arm of a balance. The disadvantage of this solution is that due to manufacturing tolerances, it is difficult to obtain spacers that have the same height in the base and in the movable section. However, any difference in height between the embeddings of the blades adds constraints in the blades which can affect the precision of the component's operation and which, in the case of an oscillator, can cause chronometric dispersions, particularly in terms of absolute rate, isochronism or rate deviation at the positions.

The present invention aims to remedy, at least in part, the aforementioned drawbacks.

To this end, the present invention relates to a horological component with separate crossed blades comprising an assembly of a first part and a second part that are superimposed, the first part comprising first and second rigid sections connected by a first elastic blade, the second part comprising third and fourth rigid sections connected by a second elastic blade, the first and third rigid sections being rigidly connected to each other, the second and fourth rigid sections being rigidly connected to each other, the first and second elastic blades extending in parallel planes and in different directions to cross without contact, a first spacer rigidly connected to or forming part of the first rigid section and a second spacer rigidly connected to or forming part of the second rigid section ensuring a height spacing of the first and second elastic blades, characterized in that the first and second spacers originate from the etching of a single substrate.

According to a particular embodiment of the invention, the first part comprises a first layer of silicon, a second layer of silicon dioxide and a third layer of silicon which originate from the etching of an SOI substrate, the first layer defining a first stage of the first rigid section, a first stage of the second rigid section and the first elastic blade, the second layer defining only a second stage of the first rigid section and a second stage of the second rigid section, the third layer defining only a third stage of the first rigid section and a third stage of the second rigid section, the second and third layers together forming the first and second spacers.

Preferably, the second part comprises a fourth layer of silicon, a fifth layer of silicon dioxide and a sixth layer of silicon which originate from the etching of an SOI substrate, the fourth layer defining only a first stage of the third rigid section and a first stage of the fourth rigid section, the fifth layer defining only a second stage of the third rigid section and a second stage of the fourth rigid section, the sixth layer defining a third stage of the third rigid section, a third stage of the fourth rigid section and the second elastic blade, the fourth and fifth layers serving as spacers ensuring a height spacing of the first and second elastic blades.

According to another embodiment of the invention, the first and second spacers are parts assembled between the first and second parts.

The present invention also relates to a horological oscillator comprising a horological component as defined above, in particular a horological oscillator comprising an assembly of such a horological component and a balance.

The present invention also relates to a method for manufacturing a horological component with separate crossed blades comprising a step of assembling a first part and a second part that are superimposed, the first part comprising first and second rigid sections connected by a first elastic blade, the second part comprising third and fourth rigid sections connected by a second elastic blade, the assembly being carried out in such a way that the first and third rigid sections are rigidly connected to each other, that the second and fourth rigid sections are rigidly connected to each other, that the first and second elastic blades extend in parallel planes and in different directions to cross without contact and that a height spacing of the first and second elastic blades is ensured by a first spacer rigidly connected to or forming part of the first rigid section and by a second spacer rigidly connected to or forming part of the second rigid section, characterized in that the first and second spacers are produced, before the assembling step, by etching a single substrate.

According to a particular embodiment, the method comprises, before the assembling step, a step of producing the first part by etching a first SOI substrate constituting said single substrate, the first part obtained at the end of this production step comprises a first layer of silicon, a second layer of silicon dioxide and a third layer of silicon which originate from the first SOI substrate, the first layer defining a first stage of the first rigid section, a first stage of the second rigid section and the first elastic blade, the second layer defining only a second stage of the first rigid section and a second stage of the second rigid section, the third layer defining only a third stage of the first rigid section and a third stage of the second rigid section, and the second and third layers together form the first and second spacers.

Preferably, the method according to the invention further comprises, before the assembling step, a step of producing the second part by etching a second SOI substrate, the second part obtained at the end of this production step comprising a fourth layer of silicon, a fifth layer of silicon dioxide and a sixth layer of silicon which originate from the second SOI substrate, the fourth layer defining only a first stage of the third rigid section and a first stage of the fourth rigid section, the fifth layer defining only a second stage of the third rigid section and a second stage of the fourth rigid section, the sixth layer defining a third stage of the third rigid section, a third stage of the fourth rigid section and the second elastic blade, the fourth and fifth layers serving as spacers ensuring a height spacing of the first and second elastic blades after the assembling step. The first and second SOI substrates may be two different substrates or a single SOI substrate.

According to another embodiment, during the assembling step the first and second spacers are assembled between the first and second parts.

Other characteristics and advantages of the present invention will appear on reading the following detailed description given with reference to the appended drawings in which:

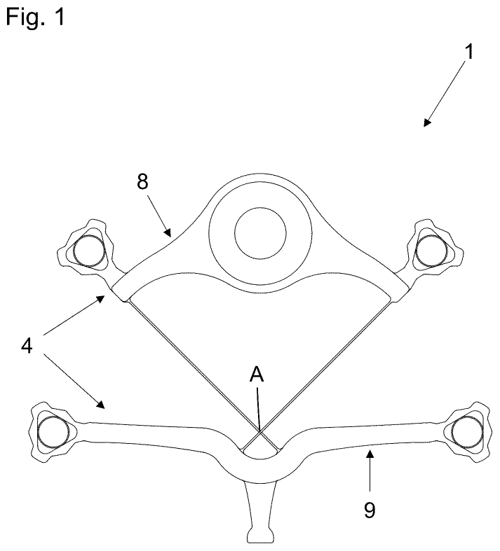

FIG. 1 is a plan view from above of a horological component according to a particular embodiment of the invention;

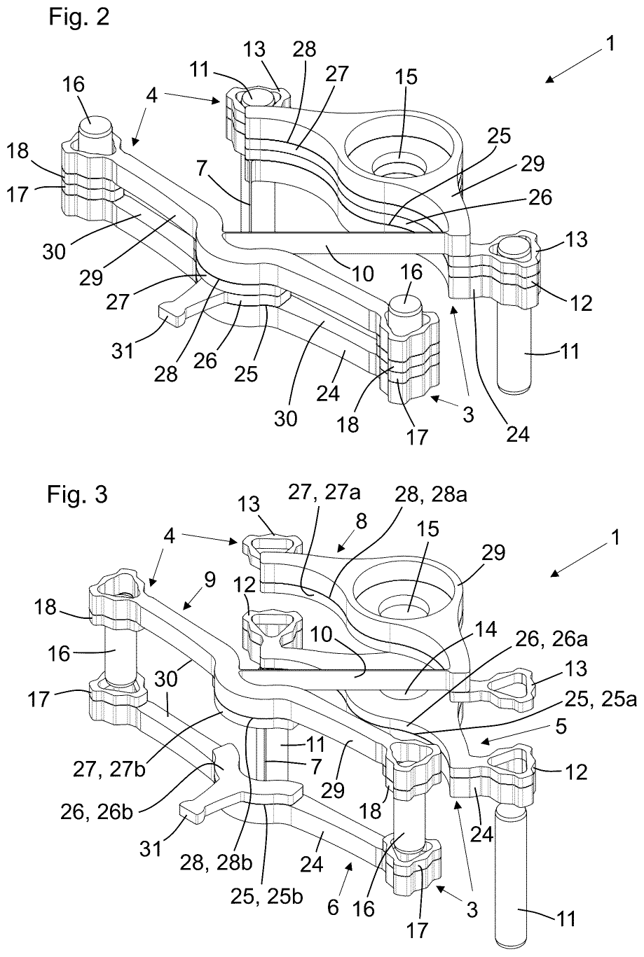

FIG. 2 is a perspective view of the horological component illustrated in FIG. 1;

FIG. 3 is an exploded perspective view of the horological component illustrated in FIG. 1;

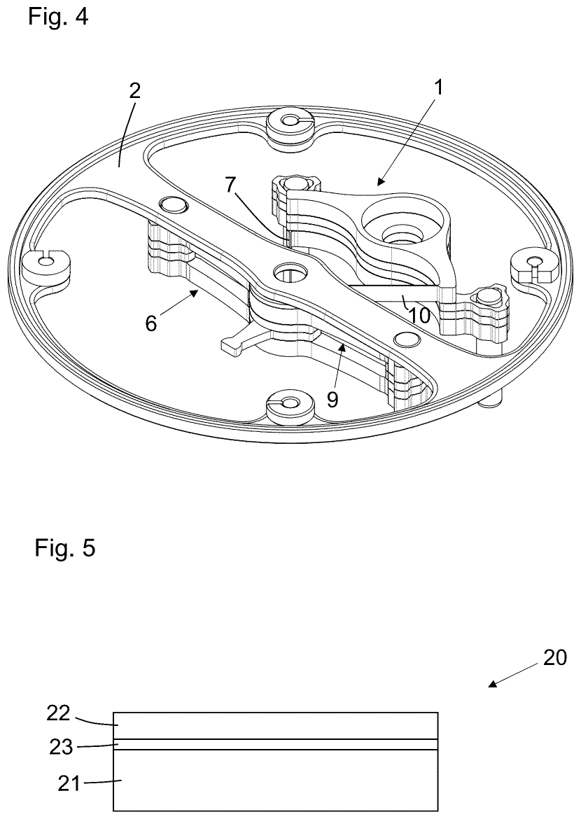

FIG. 4 is a perspective view of a horological oscillator comprising the component illustrated in FIGS. 1 to 3;

FIG. 5 is a schematic side view of an SOI type substrate used to manufacture the horological component illustrated in FIGS. 1 to 3;

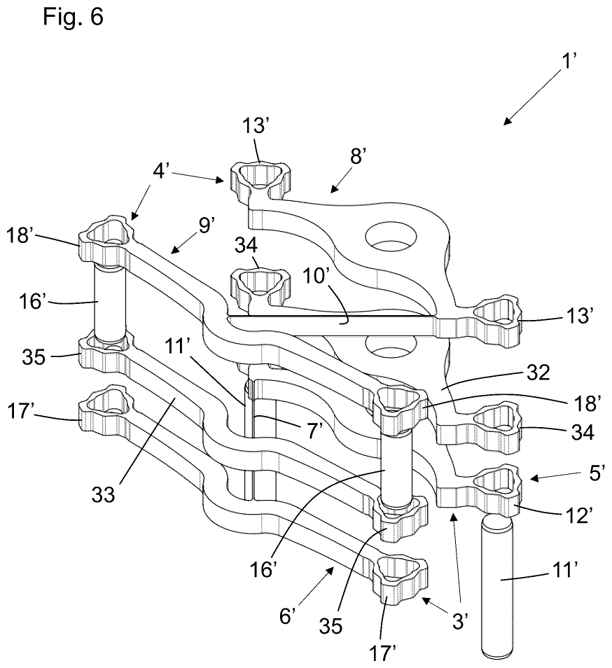

FIG. 6 is an exploded perspective view of a horological component according to another embodiment of the invention.

In all that follows, the terms “first”, “second”, “third”, etc., serve only to distinguish the different parts or sections concerned without introducing any limitation as to the order or the manner in which these parts or sections are arranged.

With reference to FIGS. 1 to 4, a horological component 1 according to a particular embodiment of the invention, intended to serve as a flexible guide support for a balance 2, is formed by an assembly of a first part 3 and a second part 4 that are superimposed. The first part 3 comprises first and second rigid sections 5, 6 connected by a first elastic blade 7. The second part 4 comprises third and fourth rigid sections 8, 9 connected by a second elastic blade 10. By the term “rigid” it is meant that the sections 5, 6, 8, 9 do not deform or undergo negligible deformation during operation of the component 1.

The first and third rigid sections 5, 8 are in contact with each other and are rigidly connected to each other by pins 11 clamped in elastic assembling collets 12, 13 of the rigid sections 5, 8 or by any other suitable assembling means or technique, such as brazing or fusion bonding. The first and third rigid sections 5, 8 together form a base of the horological component 1 intended to be fixed, for example by means of a screw passing through two aligned holes 14, 15 of the rigid sections 5, 8, in a fixed or movable frame of a horological mechanism.

The second and fourth rigid sections 6, 9 are in contact with each other and are rigidly connected to each other by pins 16 clamped in elastic assembling collets 17, 18 of the rigid sections 6, 9 or by any other suitable assembling means or technique, such as brazing or fusion bonding. The second and fourth rigid sections 6, 9 together form a movable section of the horological component 1 suspended from the base 5, 8 by the first and second elastic blades 7, 10 and guided in rotation relative to the base 5, 8 by these same elastic blades 7, 10 around a virtual axis of rotation A.

The first and second elastic blades 7, 10 extend in two different parallel planes and in two different directions to cross in top/bottom view. The crossing of the elastic blades 7, 10 at rest defines the virtual axis of rotation A, which is perpendicular to said parallel planes. In addition to suspending and guiding in rotation the movable section 6, 9, the first and second elastic blades 7, 10 exert on the movable section 6, 9 an elastic return torque tending to bring it back into an equilibrium position relative to the base 5, 8.

According to the invention, each of the first and second parts 3, 4 is a multi-layer single-piece part originating from the etching of an SOI (Silicon On Insulator) type substrate comprising a first silicon layer, a second silicon layer and an intermediate layer of silicon dioxide binding the first and second silicon layers. FIG. 5 illustrates such a substrate, 20, with the silicon layers designated 21 and 22 and the intermediate silicon dioxide layer designated 23.

More specifically, the first part 3 comprises a first layer 24 of silicon, a second layer 25 of silicon dioxide and a third layer 26 of silicon which originate from an SOI substrate. The first layer 24 defines a first stage of the first rigid section 5, a first stage of the second rigid section 6 and the first elastic blade 7 connecting these two stages. The second layer 25, represented by a line in FIGS. 2 and 3 and located between the first and third layers 24, 26, defines only a second stage of the first rigid section 5 and a second stage of the second rigid section 6. The third layer 26 defines only a third stage of the first rigid section 5 and a third stage of the second rigid section 6.

The second part 4 comprises a fourth layer 27 of silicon, a fifth layer 28 of silicon dioxide and a sixth layer 29 of silicon which originate from an SOI substrate. The fourth layer 27 is in contact with the third layer 26 and defines only a first stage of the third rigid section 8 and a first stage of the fourth rigid section 9. The fifth layer 28, represented by a line in FIGS. 2 and 3 and located between the fourth and sixth layers 27, 29, defines only a second stage of the third rigid section 8 and a second stage of the fourth rigid section 9. The sixth layer 29 defines a third stage of the third rigid section 8, a third stage of the fourth rigid section 9 and the second elastic blade 10 connecting these third stages.

Thus, the first elastic blade 7 is present only in the first layer 24 and the second elastic blade 10 is present only in the sixth layer 29, the second to fifth layers 25-28 serving as spacers separating in height (i.e. parallel to the virtual axis of rotation A) the elastic blades 7, 10 by a sufficient distance so that they cannot touch each other during the operation of the component 1 or during shocks or accelerations received by the latter. More precisely, the section 25a, 26a
of the second and third layers 25, 26 that is located in the first rigid section 5 forms a first spacer at one embedding of the elastic blades 7, 10 while the section 25b, 26b of the second and third layers 25, 26 that is located in the second rigid section 6 forms a second spacer at the other embedding of the elastic blades 7, 10. Likewise, the section 27a, 28a of the fourth and fifth layers 27, 28 that is located in the third rigid section 8 forms a third spacer at one embedding of the elastic blades 7, 10 while the section 27b, 28b of the fourth and fifth layers 27, 28 that is located in the fourth rigid section 9 forms a fourth spacer at the other embedding of the elastic blades 7, 10.

As the second and third layers 25, 26, respectively the fourth and fifth layers 27, 28, forming spacers are made with the elastic blade 7, respectively with the elastic blade 10, from an SOI substrate, their thickness is identical on the side of the base 5, 8 and on the side of the movable section 6, 9 so that the two embeddings of each elastic blade 7, 10 are at the same height and do not cause deformation of the blade parallel to the virtual axis of rotation A. In this way, the separation of the elastic blades 7, 10 by spacers is prevented from deteriorating the operating precision of the component 1.

The manufacture of the horological component 1 can be particularly precise. An SOI substrate such as the substrate 20 shown in FIG. 5 may be etched on both silicon faces by DRIE (deep reactive ion etching) throughout the depth of the silicon layers 21 and 22 to form the first and third layers 24, 26 or the fourth and sixth layers 27, 29 of the component 1, until etching is stopped by the intermediate silicon dioxide layer 23. Soaking the substrate in a hydrofluoric acid (HF) bath then removes the intermediate silicon dioxide layer 23 wherever it is not protected between two layers of silicon, to form the second or fifth layer 25, 28 of the component 1. These DRIE and wet etching techniques are well mastered and precise.

The SOI substrate can be the same for both parts 3, 4. Thus, the two parts 3, 4 can be etched simultaneously, one next to the other, in the same SOI substrate, either through different masks or through identical masks. In the latter case, one of the two parts 3, 4 is returned after its detachment from the substrate for its assembly with the other part. Alternatively, the two parts 3, 4 can be etched in different SOI substrates and then assembled after being detached from their respective substrates.

In another variant of the invention, only one of the two parts 3, 4 is multi-layer, the other part being produced by etching a single-layer silicon substrate and therefore not having a spacer.

The second to fifth layers 25-28 may be hollowed out on the side of the movable section 6, 9, in areas 30, to lighten the movable section 6, 9 and/or improve its aerodynamics.

The component 1 may comprise in its movable section 6, 9 an interaction element 31 intended to cooperate with another movable component of the horological mechanism. In the example shown, this interaction element 31 is a radial impulse element fulfilling the function of a roller pin and intended to cooperate with an escapement anchor. The interaction element 31 is preferably defined by the second and third spacer-forming layers 25, 26, as shown, or by the fourth and fifth spacer-forming layers 27, 28, or partly by the second and third layers 25, 26 and partly by the fourth and fifth layers 27, 28, i.e. is preferably located between the two parallel planes in which the elastic blades 7, 10 extend. This makes it possible not to introduce a lever arm likely to cause the movable section 6, 9 to pitch when the interaction element 31 cooperates with the partner component. Compared to an interaction element which would be defined by a spacer assembled between the first and second parts 3, 4, the connection between the interaction element 31 and the elastic blades 7, 10 is very rigid, since there is no play or tightening to manage at the spacer.

Before their assembly, the first and second parts 3, 4 or only their elastic blades 7, 10 can be coated with a layer of silicon dioxide fulfilling a function of mechanical reinforcement and/or compensation for the variation in the stiffness of the elastic blades 7, 10 as a function of the temperature. More generally, the first and second parts 3, 4 may carry any suitable coating.

The height spacing of the elastic blades 7, 10 obtained with the second to fifth layers 25-28 is typically at least 50 μm, preferably at least 100 μm, preferably at least 150 μm, preferably at least 200 μm, preferably at least 250 μm, preferably at least 300 μm.

FIG. 4 shows a horological oscillator comprising a balance 2 assembled to, and supported by, the movable section 6, 9 of the component 1. The term “balance” refers to any oscillating member, whatever its shape, which, in association with an elastic return member (here, the elastic blades 7, 10), can serve as a time base. Because it is a separate part, the balance 2 can be made of a denser material than that of the component 1 for a better quality factor and/or to reduce the size in the oscillation plane. An oscillator could however be manufactured according to the invention with a balance integral with the second or fourth rigid section 6, 9 (i.e. etched with it).

In the case of a horological oscillator, making the spacer in the form of the second to fifth layers 25-28 allows the chronometric precision not to be degraded. The horological component 1 could serve as a flexible guide support for components other than a balance, for example a rocker, or could itself be a component fulfilling, by its movable section 6, 9 guided in rotation, the function of a rocker, a lever, a rack, a finger or other.

A horological component with separate crossed blades 1′ according to another embodiment of the invention, capable of fulfilling the same functions and of being used in the same applications as the horological component 1, is illustrated in FIG. 6. It includes an assembly of a first part 3′ and a second part 4′ that are superimposed. The first and second parts 3′, 4′ are each in one piece, have the same shape as the parts 3, 4 of the previous figures but are on a single level. Thus, the first and second rigid sections 5′, 6′ of the first part 3′ are produced in the same thickness as the first elastic blade 7′, for example by etching (DRIE or other) of a single-layer substrate or by etching one of the silicon layers of an SOI substrate and eliminating the other layers. Likewise, the third and fourth rigid sections 8′, 9′ of the second part 4′ are produced in the same thickness as the second elastic blade 10′, for example by etching (DRIE or other) of a single-layer substrate or by etching one of the silicon layers of an SOI substrate and eliminating the other layers.

The first and second parts 3′, 4′, and therefore the elastic blades 7′, 10′, are separated in height by added parts forming first and second spacers 32, 33. The first spacer 32 is located between the first and third rigid sections 5′, 8′ and is rigidly connected to these sections 5′, 8′. The second spacer 33 is located between the second and fourth rigid sections 6′, 9′ and is rigidly connected to these sections 6′, 9′. The parts 3′, 4′, 32, 33 are assembled by pins 11′, 16′ clamped in elastic assembling collets 12′, 13′, 17′, 18′, 34, 35 of said parts 3′, 4′, 32, 33, but could be assembled in another way, for example by brazing or fusion bonding.

The first and second parts 3′, 4′ are for example made of silicon, quartz, silicon carbide, glass, sapphire, ruby or diamond. They can be coated with a layer of another material, for example a layer of silicon dioxide when they are made of silicon. The first and second parts 3′, 4′ can also be made of metal or alloy, and produced for example by LIGA or electroerosion.

The first and second spacers 32, 33 are obtained by etching (DRIE or other) of the same substrate, through different masks, and can therefore be considered as having exactly the same thickness, which makes it possible not to deform the elastic blades 7′, 10′ in the height direction. The substrate can be single-layer or of the SOI type. In the second case, only one of the silicon layers is etched to form the spacers 32, 33 and the other layers are then removed. The first and second spacers 32, 33 are typically made of silicon, quartz, silicon carbide, glass, sapphire, ruby or diamond. They can be coated with a layer of another material, for example a layer of silicon dioxide when they are made of silicon. Their material can be the same as that of the first and second parts 3′, 4′ or can be different.

The horological component 1′ could comprise more than one pair of added spacers, and could in particular comprise a second pair of spacers superimposed on the spacers 32, 33 and originating from the etching of the same substrate which could be the one in which the spacers 32, 33 were etched or another substrate. It would also be possible to combine the embodiment of FIGS. 1 to 3 with that of FIG. 6, i.e. to have spacers formed with the elastic blades in an SOI substrate and, in addition, added spacers of the type of the spacers 32, 33.

1. Horological component with separate crossed blades (1; 1′) comprising an assembly of a first part (3; 3′) and a second part (4; 4′) that are superimposed, the first part (3; 3′) comprising first and second rigid sections (5, 6; 5′, 6′) connected by a first elastic blade (7; 7′), the second part (4; 4′) comprising third and fourth rigid sections (8, 9; 8′, 9′) connected by a second elastic blade (10; 10′), the first and third rigid sections (5, 8; 5′, 8′) being rigidly connected to each other, the second and fourth rigid sections (6, 9; 6′, 9′) being rigidly connected to each other, the first and second elastic blades (7, 10; 7′, 10′) extending in parallel planes and in different directions to cross without contact, a first spacer (25a, 26a; 32) rigidly connected to or forming part of the first rigid section (5; 5′) and a second spacer (25b, 26b; 33) rigidly connected to or forming part of the second rigid section (6) ensuring a height spacing of the first and second elastic blades (7, 10;
7′, 10′), characterized in that the first and second spacers (25a, 26a, 25b, 26b; 32, 33) originate from the etching of a single substrate.

2. Horological component according to claim 1, characterized in that the first part (3) comprises a first layer (24) of silicon, a second layer (25) of silicon dioxide and a third layer (26) of silicon which originate from the etching of an SOI substrate, the first layer (24) defining a first stage of the first rigid section (5), a first stage of the second rigid section (6) and the first elastic blade (7), the second layer (25) defining only a second stage of the first rigid section (5) and a second stage of the second rigid section (6), the third layer (26) defining only a third stage of the first rigid section (5) and a third stage of the second rigid section (6), and in that the second and third layers (25, 26) together form the first and second spacers (25a, 26a, 25b, 26b).

3. Horological component according to claim 2, characterized in that the second part (4) comprises a fourth layer (27) of silicon, a fifth layer (28) of silicon dioxide and a sixth layer (29) of silicon which originate from the etching of an SOI substrate, the fourth layer (27) defining only a first stage of the third rigid section (8) and a first stage of the fourth rigid section (9), the fifth layer (28) defining only a second stage of the third rigid section (8) and a second stage of the fourth rigid section (9), the sixth layer (29) defining a third stage of the third rigid section (8) a third stage of the fourth rigid section (9) and the second elastic blade (10), and in that the fourth and fifth layers (27, 28) serve as spacers (27a, 28a, 27b, 28b) ensuring a height spacing of the first and second elastic blades (7, 10).

4. Horological component according to claim 2, characterized in that it comprises an interaction element (31) intended to cooperate with a partner movable component, and in that this interaction element (31) is defined at least in part by the second and third layers (25, 26).

5. Horological component according to claim 1, characterized in that the first and second spacers (32, 33) are parts assembled between the first and second parts (3′, 4′).

6. Horological component according to claim 5, characterized in that the first and second spacers (32, 33) are made of silicon, quartz, silicon carbide, glass, sapphire, ruby or diamond.

7. Horological component according to claim 1, characterized in that the first and second parts (3, 4; 3′, 4′) are assembled by pins (11, 16; 11′, 16′).

8. Horological component according to claim 1, characterized in that the first and second parts are assembled by brazing or by fusion bonding.

9. Horological oscillator comprising a horological component (1; 1′) according to claim 1.

10. Horological oscillator according to claim 9, characterized in that it comprises a balance (2) assembled to the horological component (1; 1′).

11. Method of manufacturing a horological component with separate crossed blades (1; 1′) comprising a step of assembling a first part (3; 3′) and a second part (4; 4′) that are superimposed, the first part (3; 3′) comprising first and second rigid sections (5, 6; 5′, 6′) connected by a first elastic blade (7; 7′), the second part (4; 4′) comprising third and fourth rigid sections (8, 9; 8′, 9′) connected by a second elastic blade (10; 10′), the assembly being carried out in such a way that the first and third rigid sections (5, 8; 5′, 8′) are rigidly connected to each other, that the second and fourth rigid sections (6, 9; 6′, 9′) are rigidly connected to each other, that the first and second elastic blades (7, 10; 7′, 10′) extend in parallel planes and in different directions to cross without contact and that a height spacing of the first and second elastic blades (7, 10; 7′, 10′) is ensured by a first spacer (25a, 26a; 32) rigidly connected to or forming part of the first rigid section (5; 5′) and by a second spacer (25b, 26b; 33) rigidly connected to or forming part of the second rigid section (6; 6′), characterized in that the first and second spacers (25a, 26a, 25b, 26b; 32, 33) are produced, before the assembling step, by etching a single substrate.

12. Method according to claim 11, characterized in that it comprises, before the assembling step, a step of producing the first part (3) by etching a first SOI substrate constituting said single substrate, in that the first part (3) obtained at the end of this production step comprises a first layer (24) of silicon, a second layer (25) of silicon dioxide and a third layer (26) of silicon which originate from the first SOI substrate, the first layer (24) defining a first stage of the first rigid section (5), a first stage of the second rigid section (6) and the first elastic blade (7), the second layer (25) defining only a second stage of the first rigid section (5) and a second stage of the second rigid section (6), the third layer (26) defining only a third stage of the first rigid section (5) and a third stage of the second rigid section (6), and in that the second and third layers (25, 26) together form the first and second spacers (25a, 26a, 25b, 26b).

13. Method according to claim 12, characterized in that it comprises, before the assembling step, a step of producing the second part (4) by etching a second SOI substrate, in that the second part (4) obtained at the end of this production step comprises a fourth layer (27) of silicon, a fifth layer (28) of silicon dioxide and a sixth layer (29) of silicon which originate from the second SOI substrate, the fourth layer (27) defining only a first stage of the third rigid section (8) and a first stage of the fourth rigid section (9), the fifth layer (28) defining only a second stage of the third rigid section (8) and a second stage of the fourth rigid section (9), the sixth layer (29) defining a third stage of the third rigid section (8), a third stage of the fourth rigid section (9) and the second elastic blade (10), and in that the fourth and fifth layers (27, 28) serve as spacers (27a, 28a, 27b, 28b) ensuring a height spacing of the first and second elastic blades (7, 10) after the assembling step.

14. Method according to claim 13, characterized in that the first and second SOI substrates are a single SOI substrate.

15. Method according to claim 11, characterized in that during the assembling step the first and second spacers (32, 33) are assembled between the first and second parts (3′, 4′).

16. Method according to claim 15, characterized in that the first and second spacers (32, 33) are made of silicon, quartz, silicon carbide, glass, sapphire, ruby or diamond.

17. Method according to claim 11, characterized in that the assembly of the first and second parts (3, 4; 3′, 4′) is carried out by means of pins (11, 16; 11′, 16′).

18. Method according to claim 11, characterized in that the assembly of the first and second parts is carried out by brazing or by fusion bonding.

19. Method according to claim 1, characterized in that the horological component is an oscillator.
